(19) United States
(12) Patent Application Publication
(10) Pub. No.: US 2017/0035078 A1
(43) Pub. Date: Feb. 9, 2017

(54) METHOD AND SYSTEM FOR PRODUCING A FRIED FOOD PRODUCT

(71) Applicant: Frito-Lay North America,Inc., Plano, TX (US)

(72) Inventors: Nicole BIGLIONE, Carrollton, TX (US); Justin A. FRENCH, McKinney, TX (US); Christopher James KOH, Southlake, TX (US); Austin KOZMAN, Dallas, TX (US)

(21) Appl. No.: 14/817,863

(22) Filed: Aug. 4, 2015

(51) Int. Cl. A23L 1/217; A23L 1/01; A47J 37/12; A23L 1/025

(52) U.S. Cl. CPC A23L 1/217; A23L 1/025; A23L 1/0107; A47J 37/1276; A23V 2002/00

(57) ABSTRACT

A method and system for producing potato chips with widely varying organoleptic characteristics is disclosed. Whole or sliced potatoes are subjected to pulsed electric field treatment. The potato slices are par-fried to an intermediate moisture content in a first immersion fryer using hot oil at a first temperature, and then finish fried to a final moisture content in a second immersion fryer at a second oil temperature.

### BACKGROUND OF THE INVENTION

Technical Field

The present invention relates to an improved method and system for the production of a fried food product.

Description of Related Art

Conventional potato chip products are prepared by the basic steps of slicing peeled, raw potatoes, water washing the slices to remove surface starch and frying the potato slices in hot oil until a moisture content of about 1% to 2% by weight is achieved. The fried slices are then salted or seasoned and packaged.

Raw potato slices normally have moisture contents from 75% to 85% by weight depending on the type of potato and the environmental growing conditions. When potato slices are fried in hot oil, the moisture present boils and leaves the slice.

In the past, different types of frying systems and methods have been used to produce chips with different oil contents and overall texture/mouthfeel. For example, no single known system can produce both kettle style potato chips, which tend to have a harder bite, and traditional style potato chips, which typically have a lighter, crispier texture.

Consequently, a need exists for a single system and method that can produce a wide variety of potato chip styles which are desirable for consumers.

### SUMMARY OF THE INVENTION

The proposed invention provides a method and system for producing fried food pieces. In one embodiment, food pieces are subjected to a pulsed electric field, then par-fried by immersion in hot oil at a first temperature, and then finish fried by contact with hot oil at a second oil temperature. In a preferred embodiment, the finish frying step is accomplished by passing the par-fried food pieces through a second immersion frying step.

The fried food pieces produced according to the present invention can be made with a wider variety of visual, taste, and textural qualities than was possible using previously known systems for making fried food pieces.

Other aspects, embodiments and features of the invention will become apparent from the following detailed description of the invention when considered in conjunction with the accompanying drawings. The accompanying figures are schematic and are not intended to be drawn to scale. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a schematic representation of one embodiment of the method and system of the present invention.

FIG. 2 is a graph that depicts the wide range of products that can be produced with the present invention.

FIG. 3 is a schematic representation of another embodiment of the method and system of the present invention.

### DETAILED DESCRIPTION

The present invention is directed to a method and system for producing fried potato chips with widely varying textural and mouthfeel properties. In general, when potato slices are fried in hot oil, moisture leaves the slices as steam, and the slices absorb some of the oil in which they are fried. The invention is designed to give the user more control over the properties of the finished potato chips than was previously possible with a single system or method.

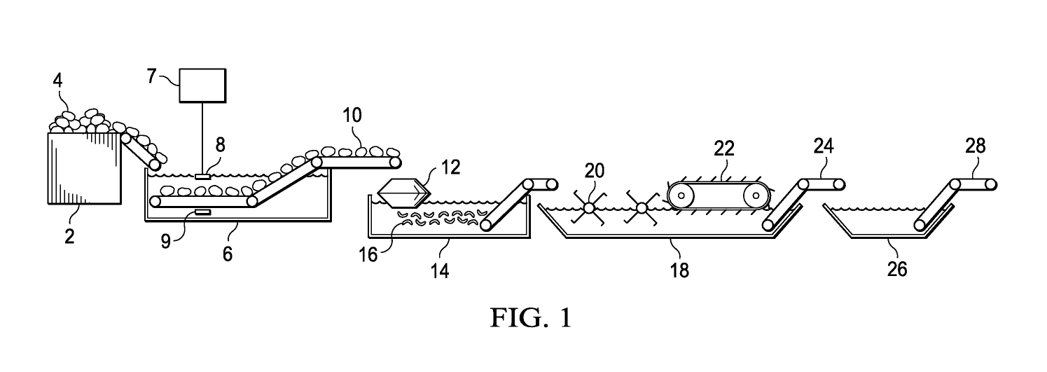

FIG. 1 gives a schematic overview of one embodiment of the system of the present invention. Whole potatoes 4 stored in hopper or bin 2 are conveyed into a pulsed electric field (PEF) treatment unit 6. In a preferred embodiment, the potatoes are subjected to PEF treatment prior to any peeling, washing or slicing step. In an alternative embodiment, the potatoes are peeled and/or sliced prior to the PEF treatment step. The PEF treatment step or unit may be positioned anywhere along the peeling to washing continuum of unit operations because regardless of the form the uncooked potatoes take, the electrical energy provided by the PEF unit will cause electroporation of the starch cells and produce the effects described herein. If it is desired to produce potato chips made from unwashed potato slices, then the PEF unit should be located before the slicer, and likewise the PEF treatment step should occur prior to any slicing step. In the PEF unit, whole or sliced potatoes are immersed in water, and conveyed between electrodes 8 and 9 (which are coupled to and powered by electrical power source 7), then removed from the PEF unit by a takeout means, preferably a takeout conveyor. The potatoes can be conveyed between electrodes 8 and 9 by any known method, such as pumping as a fluidized stream, flumed, or by gravity feed.

The particular construction of the PEF unit can be any construction capable of producing the voltage/power levels, number of pulses, total energy input, pulse width, pulse polarity, pulse shape, conductivity of the fluid and materials being treated, and other processing conditions used for the present invention. Several different types of PEF electrical generators are described in U.S. Pat. Nos. 3,980,901, 4,559,943, 4,750,100, 6,043,066, and 6,214,297. The PEF generator 7 is electrically connected to (or coupled to) electrodes 8 and 9, which can be made of any conductive metal, preferably titanium or stainless steel.

The PEF-treated potatoes 10 are transferred to slicing apparatus 12 (or slicer), which drops potato slices 16 into a water wash step 14. The wash step is optional. The optionally washed potato slices are then removed from the wash step through any appropriate means, preferably a takeout conveyor, and into a first immersion frying step 18.

In one embodiment, the potato slices are optionally marinated in a salt solution prior to frying. The salt solution can comprise any soluble, edible salt, such as sodium chloride or calcium chloride. In one embodiment, the marination solution comprises between 1% and 5% by weight salt, and the dwell time for the marination step is between 5 and 15 seconds. The marination step has been found to osmotically weaken the cell walls of the potato slice to produce a similar effect in the final product as the pulsed electric field treatment. When marination is combined with PEF treatment, a potato slice can be produced with a unique, hard, glassy texture, which has not been produced by the prior art.

In a preferred embodiment, the frying oil entering the first immersion fryer is maintained at an initial temperature between about 320° F. to about 380° F. more preferably between about 335° F. and about 370° F. Any conventional frying medium can be used in accordance with various embodiments of the present invention, including frying mediums with digestible and/or non-digestible oils. In one embodiment, the fryer is a continuous single flow or multizone fryer which utilizes devices such as paddle wheels, 20, and a submergible conveyor belt 22 (sometimes referred to as a “submerger”) to control the flow of potato slices (not shown) through the first immersion fryer 18.

In one embodiment of the present invention, the potato slices are par-fried to an intermediate moisture content and then removed from the fryer 18, preferably by a perforated endless belt conveyor 24 (sometimes referred to as a “takeout conveyor”). If no hot oil is added to the frying oil or if the oil is not otherwise heated during frying, at the location the perforated endless belt conveyor 24 contacts the frying oil, the frying oil comprises a final par-fry temperature of between about 290° F. to about 330° F. and more preferably between about 300° F. to about 320° F. The final par-fry oil temperature, as that term is used herein, of the first immersion frying step is the oil temperature at the location of the takeout means. For a continuous frying process, the takeout means will typically comprise a takeout conveyor 24, as depicted in FIG. 1, and for a batch process the takeout means will typically be a perforated basket or takeout conveyor. In either case, the final par-fry oil temperature is the temperature of the oil at the location of the food pieces as they are being removed from the oil by the takeout means.

In one embodiment, the potato slices exit the par-frying step comprising an oil content of between about 22% and about 45% by weight, and an intermediate moisture content above 2% by weight, or in another embodiment above 3% by weight. In one embodiment, the intermediate moisture content is between about 1.5% and about 15% by weight, or in another embodiment, between about 3% and about 10% by weight, or combinations of the foregoing ranges. In a preferred embodiment, the par-fried potato slices comprise an intermediate moisture content between about 2% and 10% by weight, and most preferably between about 3% and 6% by weight. Preferably, the final moisture content of the potato slices is less than about 10%, and more preferably less than about 5%, by weight of the potato slices below the intermediate moisture content of the potato slices.

As shown in FIG. 1, the slices are then subjected to a hot oil finish frying step, which in a preferred embodiment, is accomplished by transferring the par-fried potato slices into a second immersion fryer 26. The oil used for the second immersion fryer is preferably from a separate oil source than the first immersion fryer, or uses a separate heat exchanger. In one embodiment, the oil source is a source of fresh or reconditioned oil, and in another embodiment, the oil source is the same oil used in the immersion fryer. In one embodiment, the temperature of the oil used for the second immersion frying step is greater than the final par-fry oil temperature of the first immersion frying step.

Applicants have measured the vapor pressure of water inside a potato slice at different product temperatures and moisture contents. It was found that in order to maintain the vapor pressure inside the potato chip above 14.7 psia (or approximately atmospheric pressure), the product temperature must be above about 270° F. to 310° F. at moisture contents ranging from 1% to 2% moisture content. Therefore, Applicants theorize that the product temperature must be at least this high in order for water vapor inside the potato chip to resist the absorption of oil via capillary action. In fact, the product temperature must likely be even higher than these temperatures to overcome gravitational and capillary forces that may also favor absorption of oil, and will certainly need to be higher if water vapor is used to expel oil from the void spaces within the potato chip. Moreover, the oil temperature must be higher than the desired product temperature to account for the commercially needed high rates of heat transfer between the oil and the product. In fact, Applicants have discovered that when an oil temperature of 340° F. is used in the finish frying step, no oil is removed or absorbed in the final product as compared to products that are fried to their final moisture content in one frying step. By contrast, a finish frying oil temperature of 290° F. causes more oil to be absorbed by the final product, and a finish frying oil temperature of 390° F. causes less oil to be absorbed in the final product. Therefore, Applicants have found that the oil temperature used during the finish frying step can be used to modify the oil content in the final product, including raising, lowering or maintaining the oil content at a level that is equal to the oil content found in food products fried in a single frying step.

In one embodiment, the temperature of the oil in the second immersion frying step is at least about 350° F., and in a preferred embodiment at least about 385° F., if it is desired to produce a reduced oil food product. In a preferred embodiment, the temperature of the oil in the second immersion fryer is greater than 340° F. and less than 415° F. In another embodiment, the difference between the final par-fry oil temperature in the first frying step and the initial finish-fry oil temperature in the finish frying step (the second immersion fryer) is at least 30° F. In a preferred embodiment, the difference is at least 50° F.

A known process for single-stage continuous immersion frying of potato slices uses an initial oil temperature of 350° F. to 360° F., a final oil temperature of about 270° F. to 320° F., and a residence time of about 190 seconds. If hot oil is not added to the system, the oil cools as the food pieces are fried. The potato slices exit this frying process at a moisture content of about 1.4% by weight. In one embodiment of the inventive process described herein, potato slices are immersion fried in the first immersion fryer at about the same initial oil temperature and on the same continuous frying equipment, but the residence time in the first immersion fryer is reduced to about 80 seconds to 180 seconds, or in a preferred embodiment the residence time is reduced to about 80 seconds to 130 seconds. Then, as described above, the slices are removed from the first immersion fryer, preferably as a product bed on a takeout conveyor, and subjected to finish frying by transferring them directly into a second immersion fryer. A direct transfer would be consistent with a continuous frying process and would not include any intermediate refrigeration or freezing step. In a preferred embodiment, the transfer step comprises a transfer time of less than 10 seconds, or more preferably, less than 5 seconds.

Other continuous or batch frying processes can be modified according to the teachings herein. One example of a continuous frying process is a continuous kettle process that begins with an initial oil temperature between 290° F. and 330° F., has a residence time of about 8-10 minutes, and subjects the potato slices to a U-shaped temperature curve inside the fryer, with a final par fry oil temperature of between about 290° F. and 330° F.

In a preferred embodiment, the takeout conveyor from the first frying step can feed the par-fried food products into a second volume of oil maintained at a higher temperature than the oil temperature used for the first immersion frying step. More than one conveyor, or a different transfer means, may be used between the frying steps. For washed, par-fried potato slices, preferably the residence time in the second immersion fryer is less than about 10 seconds, and more preferably less than about 5 seconds, to bring the moisture content of the potato slices to a final moisture content of less than 2% by weight for washed potato slices, and less than about 2.5% by weight for unwashed kettle-style potato chips. The finish fried food products can be removed from the second volume of oil by any convenient means, such as a second takeout conveyor or a perforated basket.

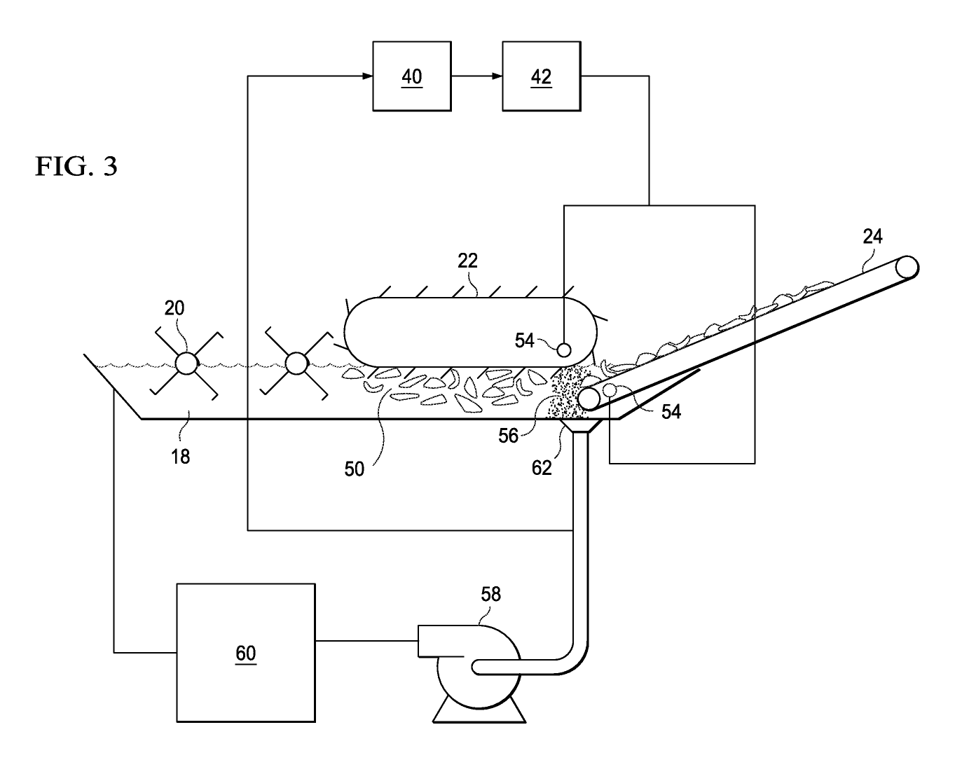

In still another embodiment, the products being fried by immersion in hot oil can be subjected to a finish frying step by providing a submerged oil curtain inside the frying oil. One example of a submerged oil curtain is depicted by the shaded region 56 of FIG. 3. In the embodiment depicted in FIG. 3, the submerged oil curtain 56 is provided by at least one oil dispenser 54 located above the product bed 50 as it passes under the submerger 22. In a preferred embodiment, the hot oil dispenser 54 is located inside the submerger belt 22, such that the oil falls down through the submerger belt from the inside, and onto the product bed. In another embodiment, the submerged oil curtain 56 is supplemented by at least one oil dispenser 54 located below the product bed 50 as it moves from the submerger 22 to the takeout conveyor 24. The oil dispensers 54 can be fed by a fresh oil source 40 which is heated by a heat exchanger 42, but may also be fed, in whole or in part, by oil recycled from the fryer. The submerged oil curtain can represent a narrow band or region of oil between the submerger 22 and takeout conveyor 24. The submerged oil curtain is restricted to the regions inside the fryer near the oil dispensers 54 because the recirculation system drain 62 is located near the product exit end of the fryer. The recirculation system uses at least one pump 58 and heat exchanger 60 to recycle the oil to the product entrance end of the fryer. This maintains a well-defined region of oil in close proximity to the submerger 22 and takeout conveyor 24 that constitutes the submerged oil curtain 56.

Providing a submerged oil curtain may provide advantages over other embodiments with respect to oil quality and product coverage. Because the oil in the submerged oil curtain will be in contact with air for a short period of time, the oil in the submerged oil curtain may not oxidize quickly. Also, the fact that the products are already submerged in oil when they pass through the submerged oil curtain will also help provide more uniformly cooked food products. As can be seen, the oil curtain is in close proximity to the takeout conveyor.

Applicants have discovered that the inventive process and system provides a practitioner far more control over final product characteristics than prior art systems.

First, the oil content of the fried food products that are produced by the invention can be controlled precisely, and independent of final product texture. In the prior art, if a low oil product was desired, the product would either need to be a kettle-style chip, which is typically unwashed and fried according to a specific frying oil temperature profile, or a product that had the oil mechanically stripped from the outer surfaces. A kettle style chip has what is generally referred to as a “hard bite” produced by a combination of oil temperature profile and the starch crust on the exterior surface of the potato chip. A mechanically stripped potato chip has been described by some as having a dry mouthfeel, which is believed to be due at least in part to the fact that the oil on the exterior surface of the chip has been stripped. With no oil on the outer surface to be detected by the consumer when the chip is first placed in the mouth, some consumers experience them as having a dry mouthfeel.

The present invention overcomes these difficulties, especially when providing a reduced oil content product, by using the high temperature finish frying step described above. Applicants have found that the system can produce a reduced oil product which has a texture and mouthfeel that is virtually indistinguishable from prior art potato chips produced using a single stage continuous fryer. Even though the invention is not limited by theory, Applicants believe that the hot oil finish frying step can reduce oil content in several ways.

The viscosity of frying oil generally decreases with increasing temperature. Applicants believe that the hotter oil used in the finish frying step of the present invention drains more efficiently from the slices on the takeout conveyor.

The hot oil also likely causes a rapid increase in chip temperature which converts most of the water remaining inside the potato slices into steam, which exits the slices. Applicants believe that this steam also ejects a portion of the oil that had been absorbed into the slice during immersion frying. Applicants have confirmed this by analyzing computed tomography (CT) scans of potato slices produced using the inventive method described herein and other methods. More oil is, in fact, located at the outer surfaces relative to the amount located in the interior of the chip, than is seen in prior art potato chips.

Also, because the food pieces are kept hot (or, maintained at a temperature above about 270° F.) while being transferred to the second frying step and during the second frying step, water vapor present inside the potato chip will remain in the vapor state for a longer period of time and resist oil uptake that is believe to occur during cooling.

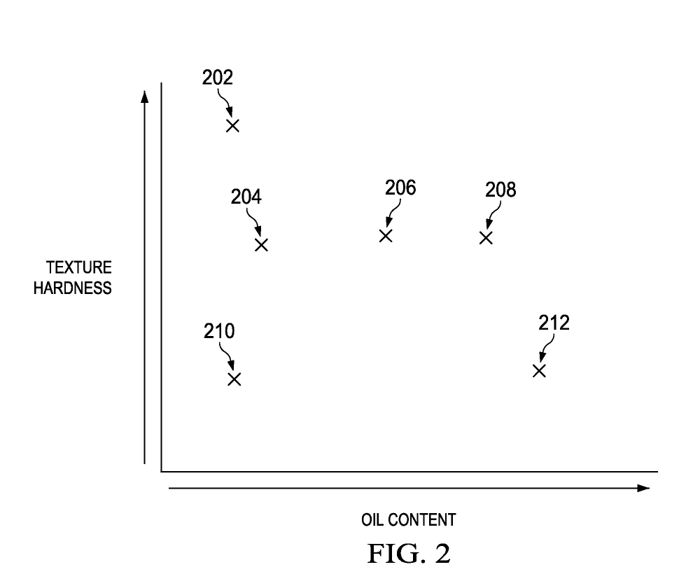

The PEF treatment allows the practitioner of the present invention to control the textural hardness of a potato chip independently of oil content. For example, the region identified as 202 in FIG. 2 represents the location that a kettle or “kettle style” potato chip would fall on a texture hardness/oil content graph. It has a hard bite and low oil content. The region identified as 212 in FIG. 2 is where a classic style potato chip with a light, crispy texture and higher oil content would be found. As described by the following examples, the inventive system disclosed and claimed herein can be used to make potato chips that fall into different locations across the entire spectrum of oil contents and product textures represented by FIG. 2.

### EXAMPLES

FIG. 2 depicts a product map that illustrates the wide variety of potato chips that can be produced according to the system of the present invention, one embodiment of which is depicted in FIG. 1. As depicted in FIG. 2 therein, potato chips that have widely varying oil content and texture hardness can be produced. The examples described below were produced using a system generally similar to the example shown in FIG. 1—a two-stage immersion frying system with a PEF treatment unit that was used to treat potatoes before they were peeled or sliced.

In a control example, the PEF unit was turned off, and the two-stage immersion frying system was used to produce chips similar in oil content and texture to “classic” style potato chips, with potato slices that had been washed prior to frying. For the control example run, the PEF treatment unit was turned off so that the potatoes were not subjected to PEF treatment. The initial oil temperature in the first immersion fryer was about 340° F. and the temperature of the oil near the first takeout conveyor, after a dwell time of about 3 minutes, was about 45° F. lower than the initial temperature, or about 295° F. The oil temperature in the second immersion fryer was about 320° F. with a dwell time of about 3 seconds, producing potato chips with a moisture content of 1.35% and an oil content of about 36%. Again, this potato chip falls within the region identified by 212 in FIG. 2.

In a first comparative example, the PEF unit was turned on to a low power setting and used to treat the potatoes prior to peeling, slicing or washing. Also, the second immersion fryer was run at a higher oil temperature to produce potato chips with lower oil content than control. In particular, the PEF treatment unit was set to deliver about 3 kJ of power per kilogram of water passing through it (3 kJ/kg of water). The power level was set by passing water only through the PEF treatment unit—no potatoes. This power level was produced using an exponential wave function having an energy per pulse of 14.1 J for 55 pulses at 0.1 microFarad (μF) capacitance. The total energy produced over those 55 pulses was about 0.78 kJ. At a rate of 2000 lbs. of potatoes per hour, the average power per output of the PEF unit 0.0036 kW/lb/hr.

The oil temperatures used in the first immersion fryer were similar to those used in the control example, but the oil temperature used in the second immersion fryer was between 345° F. and 350° F., with a residence time of 6.5 seconds. The oil content of the first example potato chips was 29.19% and the moisture content was 1.66%. This first comparative example potato chip falls into the region identified by 210 in FIG. 2. In a second comparative example, the PEF unit was used to treat the potatoes prior to peeling, slicing or washing, at a higher power level than the first comparative example. In particular, the PEF treatment unit was set to deliver about 17.6 kJ per kilogram of water passing through it (17.6 kJ/kg). This power level was produced using an exponential wave function having an energy per pulse of 4.32 J for 106 pulses at 0.1 μF capacitance. The total energy produced over those 106 pulses was about 4.58 kJ. At a rate of 2000 lbs. of potatoes per hour, the average power per output of the PEF unit 0.014 kW/lb/hr. The oil temperatures used in the first and second immersion fryers were similar to control, but the dwell time for the first immersion fryer was increased to 4.5 minutes, and the dwell time in the second immersion fryer was increased to 6 seconds. This produced a potato chip with a moisture content of 1.68% and an oil content of 30.42%. This second comparative example potato chip falls into the region identified by 206 in FIG. 2, which is slightly lower in oil content but with a harder texture than control.

In a third comparative example, the PEF unit was used to treat potatoes prior to peeling or slicing, but the slices were not washed prior to frying in this example. The PEF treatment unit was set to deliver about 13.7 kJ per kilogram of water passing through it (13.7 kJ/kg). This power level was produced using an exponential wave function having an energy per pulse of 43.2 J for 77 pulses at 0.1 μF capacitance. The total energy produced over those 77 pulses was about 3.33 kJ. At a rate of 2000 lbs. of potatoes per hour, the average power per output of the PEF unit 0.014 kW/lb/hr. The oil temperatures and dwell times used in the third comparative example were similar to those used in the second comparative example. The potato chips produced in the third comparative example had a moisture content of about 1.96% and an oil content of about 30.45%, and fall into the region identified by 208 in FIG. 2. This example demonstrates that a lower PEF power level can be used for an unwashed potato slice to create a potato chip similar in texture and oil content that made using a washed potato slice treated at higher PEF power levels.

In a fourth comparative example, the PEF unit was used to treat potatoes prior to peeling or slicing, but the slices were not washed prior to frying in this example. The PEF unit delivered about 17.6 kJ per kilogram of water passing through it (17.6 kJ/kg). This power level was produced using an exponential wave function having an energy per pulse of 43.2 J for 106 pulses at 0.1 μF capacitance. The total energy produced over those 106 pulses was about 4.58 kJ. At a rate of 2000 lbs. of potatoes per hour, the average power per output of the PEF unit 0.014 kW/lb/hr. The oil temperature and dwell time in the first immersion fryer were similar to comparative examples 2 and 3, but the conditions in the second immersion fryer were similar to comparative example 1. The result of comparative example 4 was a potato chip having a moisture content of 1.72% and an oil content of about 26%. The comparative example 4 potato chips would fall within the region identified by 204 in FIG. 2.

In a fifth comparative example, the PEF unit delivered about 17.6 kJ/kg to the water prior to peeling, washing and slicing. The first immersion fryer conditions were similar to those used for comparative example 1, but the oil temperature used in the second immersion fryer was about 355° F. The slice thickness used in comparative example 5 was also slightly larger than the slice thickness of the other examples discussed previously. The potato slices made in comparative example 5 comprise a moisture content of 2.15% and an oil content of about 23.72%, and fell into the region identified by 202 in FIG. 2. Note that although comparative example 5 was a washed potato slice, it comprised an oil content and texture that made it resemble a kettle-style potato chip (which is unwashed). This is made possible by use of the inventive system described herein.

In a sixth comparative example, potato chips were produced according to the conditions set forth in comparative example 5, with the addition of a marination step between the slicing and first immersion frying steps. The marination step comprised marinating the potato slices in a 2% salt solution for between 5 and 10 seconds. The resulting potato chips had a moisture content of about 2.25%, an oil content of about 22.67%, and fell into a textural hardness region just above the region identified by 202 in FIG. 2.

It will now be evident to those skilled in the art that there has been described herein a method and system that can be used to produce fried food products that have widely varying textural and mouthfeel characteristics. Although the invention hereof has been described by way of a preferred embodiment, it will be evident that other adaptations and modifications can be employed without departing from the spirit and scope thereof. The terms and expressions employed herein have been used as terms of description and not of limitation; and thus, there is no intent of excluding equivalents, but on the contrary it is intended to cover any and all equivalents that may be employed without departing from the spirit and scope of the invention.

In sum, while this invention has been particularly shown and described with reference to a preferred embodiment, it will be understood by those skilled in the art that various changes, in form and detail may be made therein without departing from the spirit and scope of the invention.

What is claimed is:

1. A method for making potato chips comprising the steps of:
providing a plurality of potatoes;
treating the potatoes with a pulsed electric field;
slicing the potatoes to produce a plurality of potato slices.
par-frying the potato slices by immersion in a first volume of oil, wherein the first volume of oil comprises an initial par-fry oil temperature and a final par-fry oil temperature, to produce par-fried potato slices;
removing the par-fried potato slices from the first volume of oil; and
finish frying the par-fried potato slices by contact with a second volume of oil at an initial finish-fry oil temperature to produce the potato chips.

2. The method of claim 1 wherein the initial finish-fry oil temperature is higher than the final par-fry oil temperature.

3. The method of claim 1 wherein the finish frying step comprises finish frying the par-fried potato slices by immersion frying.

4. The method of claim 1 wherein the treating step occurs before the slicing step and any peeling step.

5. The method of claim 1 wherein the treating step occurs after the slicing step.

6. The method of claim 1 wherein the par-frying step comprises par-frying the potato slices to an intermediate moisture content of between 1.5% and about 15% by weight, wherein the finish frying step comprises finish frying the par-fried potato slices to a final moisture content of less than 2% by weight and less than the intermediate moisture content.

7. The method of claim 1 wherein the finish frying step comprises immersion frying the par-fried potato slices for less than 10 seconds.

8. The method of claim 1 wherein the finish frying step comprises immersion frying the par-fried food pieces for less than 5 seconds.

9. The method of claim 1 wherein treating step provides an amount of energy that is varied to provide a target textural hardness in the potato chips, and wherein the initial finish fry oil temperature is varied to provide a target oil content in the potato chips.

10. The method of claim 1 further comprising a transfer time between the par-frying and finish frying steps of less than 10 seconds.

11. The method of claim 1 further comprising a transfer time between the par-frying and finish frying steps of less than 5 seconds.

12. The method of claim 1 further comprising, prior to the par-frying step, marinating the potato slices in a salt solution for between 5 and 15 seconds.

13. The method of claim 12 wherein the salt solution comprises a salt concentration of between 1% and 5% by weight, and wherein the salt is at least one of sodium chloride and calcium chloride.

14. A system for continuously producing fried potato chips comprising:
a pulsed electric field generator coupled to at least two electrodes, wherein the electrodes deliver a pulsed electric field to a stream of potatoes;
a slicer that converts the stream of potatoes into potato slices;
a first immersion fryer having a first volume of oil, wherein the first volume of oil comprises an initial par-fry oil temperature and a final par-fry oil temperature, that receives the potato slices and produces par-fried potato slices;
a takeout means that removes the par-fried potato slices from the first immersion fryer; and
a second immersion fryer using a second volume of oil at an initial finish-fry oil temperature that receives the par-fried potato slices removed from the first immersion fryer, wherein the initial finish-fry oil temperature is greater than the final par-fry oil temperature.

15. The system of claim 14 wherein the pulsed electric field generator receives the stream of potatoes before the stream of potatoes passes through the slicer.

16. The system of claim 14 wherein the pulsed electric field generator receives the stream of potatoes after they have passed through the slicer.

17. The system of claim 14 wherein the takeout means is at least one takeout conveyor and optionally at least one transfer conveyor.

18. The system of claim 14 further comprising a marination tank that receives potato slices prior to the first immersion fryer, wherein the marination tank comprises a salt solution.
